(19) United States
(12) Patent Application Publication
(10) Pub. No.: US 2007/0089554 A1
(43) Pub. Date: Apr. 26, 2007

(54) Tetrahedron rack and pinion drive

(76) Inventors: Koenraad A. Gieskes, Deposit, NY (US); John E. Danek, Vestal, NY (US)

Correspondence Address: SCHMEISER, OLSEN & WATTS, 22 CENTURY HILL DRIVE, SUITE 302, LATHAM, NY, 12110, US

(21) Appl. No.: 11/256,065

(22) Filed: Oct. 21, 2005

(51) Int. Cl. F16H 1/04; F16H 27/02

(52) U.S. Cl. 74/422; 74/89.17

(57) ABSTRACT

A spindle assembly drive system that includes a rack unit, a drive gear, a motor, and a plurality of bearings, such that said rack unit laterally moves in a first axis with little or no movement in or rotation about any other axis.

### BACKGROUND OF THE INVENTION

1. Technical Field

The present invention relates to a low friction tetrahedron rack and pinion drive, and associated method of use, for providing vertical motion to a vacuum spindle on a printed circuit board component pick and place machine.

2. Related Art

Various drive systems exist for providing motion to vacuum spindles that are typically used on surface mount placement machines used in the printed circuit board (“PCB”) manufacturing industry. The typical “up” and “down” vertical motion of the spindle(s) allow for the picking and placing of components on the PCB.

As can be seen in related art shown in FIG. 1, spindle assembly 50 is moved up and down via a typical leadscrew drive system 100. Leadscrew drive system 100 comprises a motor 102, leadscrew 104, ball nut 106, and linear bearing assembly 108. Linear bearing assembly 108 attaches to ball nut 106 and spindle assembly 50 attaches to linear bearing assembly 108 via bracket 112. Linear bearing assembly 108 further comprises linear bearing carriage 109 and linear bearing rail 110. As motor 102 rotates leadscrew 104, ball nut 106 moves in the Z-axis and thus moves linear bearing carriage 109 in the Z-axis as it rides on linear bearing rail 110. Other related art drive systems also exist that comprise a motor such as motor 102, a linear bearing assembly such as linear bearing assembly 108, and means such as a belt drive and/or a rack & pinion drive (not shown) operable to translate the drive from the motor to the linear bearing assembly. Linear bearing assembly 108 controls the positional precision of the various related art drive systems by not allowing the drive systems to move laterally in either the X or Y-axis or to rotate about the X, Y, or Z-axis. These related art drive systems, such as drive system 100 depicted in FIG. 1, require a larger servo motor, such as motor 102, due to the higher friction of the linear bearing assembly 108, which then in turn increases the size and weight of the overall drive system 100 and requires extraneous means to control the touchdown force exerted by the tip of the nozzle. In addition, the linear bearing assembly 108 is costly and requires periodic maintenance in the form of lubrication.

A drive system for use with placement machine spindles, and a method, is needed that is lower in cost and addresses at least one of the aforementioned maintenance, weight, size, and friction issues.

### SUMMARY OF THE INVENTION

The present invention provides a drive system that is easily maintained and lightweight, has reduced friction issues and is lower in cost.

In a first general aspect, the present invention provides a spindle assembly drive system comprising: a rack unit, having a plurality of teeth; a drive gear, engaged to said rack unit, providing a first contact point and a second contact point to said rack unit; a motor, engaged to said drive gear, providing rotational force to said drive gear; and a plurality of bearings, configured to operate having at least a third contact point and a fourth contact point engaged with said rack unit, wherein said rack unit laterally moves in a first axis.

In a second general aspect, the present invention provides a method comprising:
providing a rack unit, having a plurality of teeth; rotatably engaging a drive gear to said rack unit; providing a plurality of bearings rotatably engaged with said rack unit; and moving said rack unit along a first axis by engaging a motor providing rotational force with said drive gear operable with said rack unit; wherein said plurality of bearings and said drive gear prevent movement of said rack unit along a second axis and a third axis.
   In a third general aspect, the present invention provides a drive system comprising: a motor; a drive gear, operatively attached to said motor; a rack unit, engaged to said drive gear, said rack unit further comprising a first roller surface; and two bearings rotatably engaged to said first roller surface; wherein said drive gear and two bearings provide at least four support points to said rack unit.

The present invention method and structure may be used as a drive system for spindles on surface mounted placement machines.

### BRIEF DESCRIPTION OF THE DRAWINGS

FIG. 1 depicts a front perspective view of a spindle assembly attached to a related art drive system.

FIG. 2 depicts a front perspective view of a spindle assembly attached to low friction tetrahedron rack and pinion drive system, in accordance with embodiments of the present invention.

FIG. 3 depicts a close-up front perspective view of a low friction tetrahedron rack and pinion drive system, in accordance with embodiments of the present invention.

FIG. 4 depicts a bottom sectional view of the embodiment of FIG. 3.

FIG. 5A depicts a front elevation view of a rack unit, in accordance with embodiments of the present invention.

FIG. 5B depicts a bottom sectional view of a rack unit, in accordance with embodiments of the present invention.

FIG. 6 depicts a front elevation view of a drive gear, in accordance with embodiments of the present invention.

FIG. 7 depicts a superimposed tetrahedron pyramid of the embodiment of FIG. 3.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc. and are disclosed simply as an example of an embodiment. The features and advantages of the present invention are illustrated in detail in the accompanying drawings, wherein like reference numerals refer to like elements throughout the drawings.

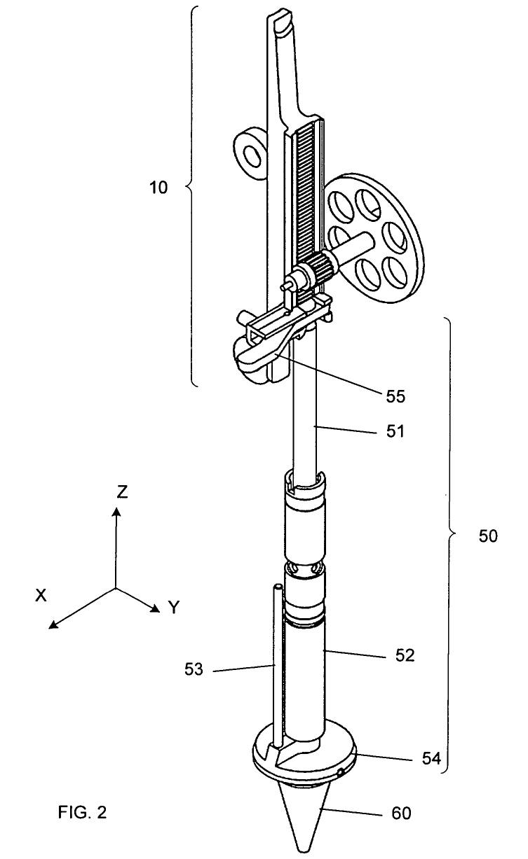

FIG. 2 illustrates a front perspective view of a spindle assembly 50 attached to a low friction tetrahedron rack and pinion drive system 10, in accordance with an embodiment of the present invention. Rack and pinion drive system 10 may provide the motive force to a vacuum spindle 60 (mounted at the distal end of spindle assembly 50) in a component placement machine (e.g., “pick & place machine”) (not shown).

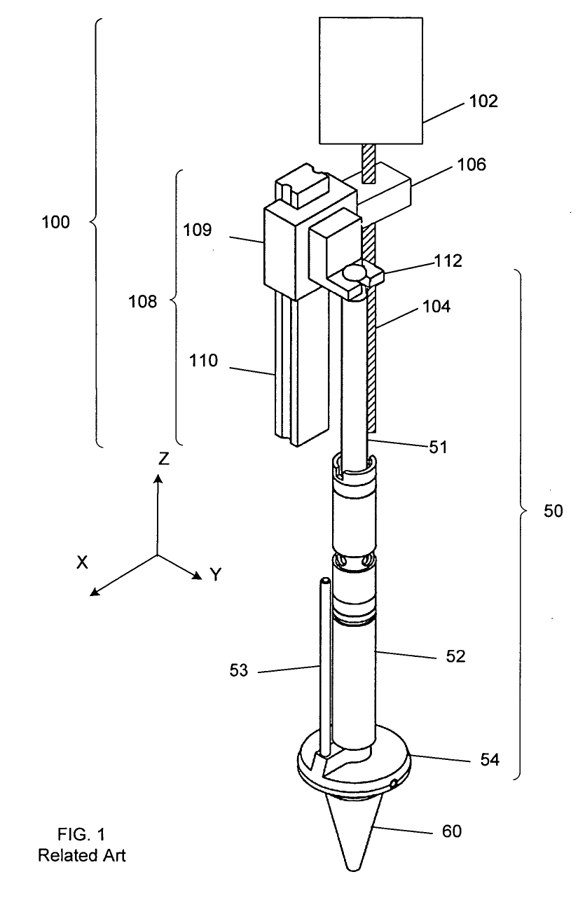

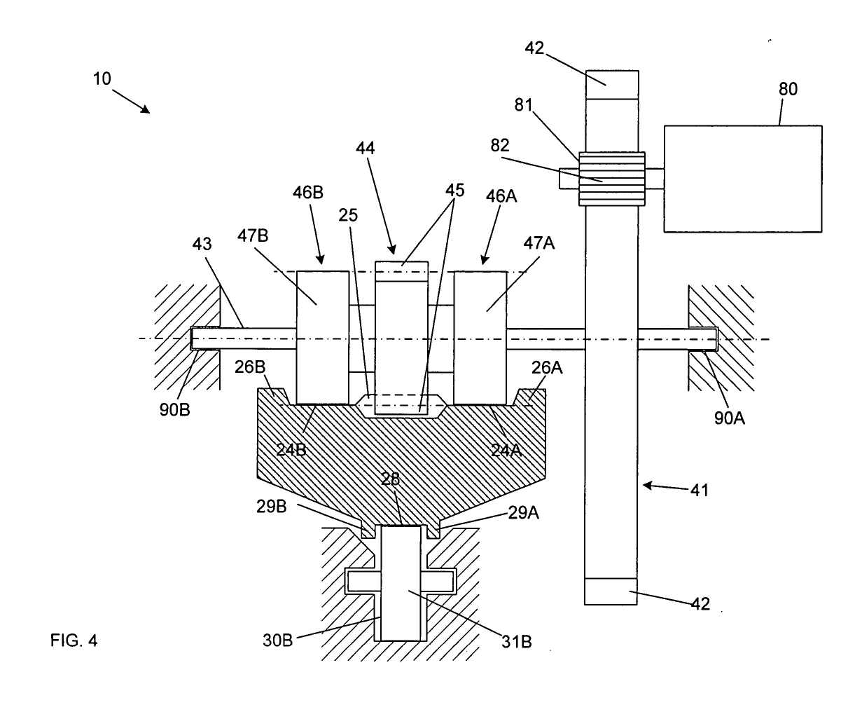

Spindle assembly 50 may comprise a spindle 51 housed in an outer housing 52. Spindle 51 may attach to drive system 10 via a release catch 55. At the distal end of outer housing 52 may be a nozzle adapter 54 upon which vacuum nozzle 60 mounts. Theta pin 53 may attach to a theta motor (not shown) to rotate spindle assembly 50 about the Z-axis such that vacuum nozzle 60 may be oriented to the correct theta position for picking and placing components. Rack and pinion drive system 10 may move spindle assembly 50 in the Z-axis. In this embodiment, rack and pinion drive system 10 does not require a linear bearing assembly, such as linear bearing assembly 108 depicted in FIG. 1 and common in the related art, to control positional precision thus reducing the friction of drive system 10 as well as the maintenance requirements of drive system 10. Since there is less friction, drive system 10 may allow the use of a miniature servo motor 80 (See FIG. 4) thereby reducing the size and weight of drive system 10. In addition, drive system 10 no longer requires lubrication of a linear bearing assembly thus reducing the maintenance of drive system 10.

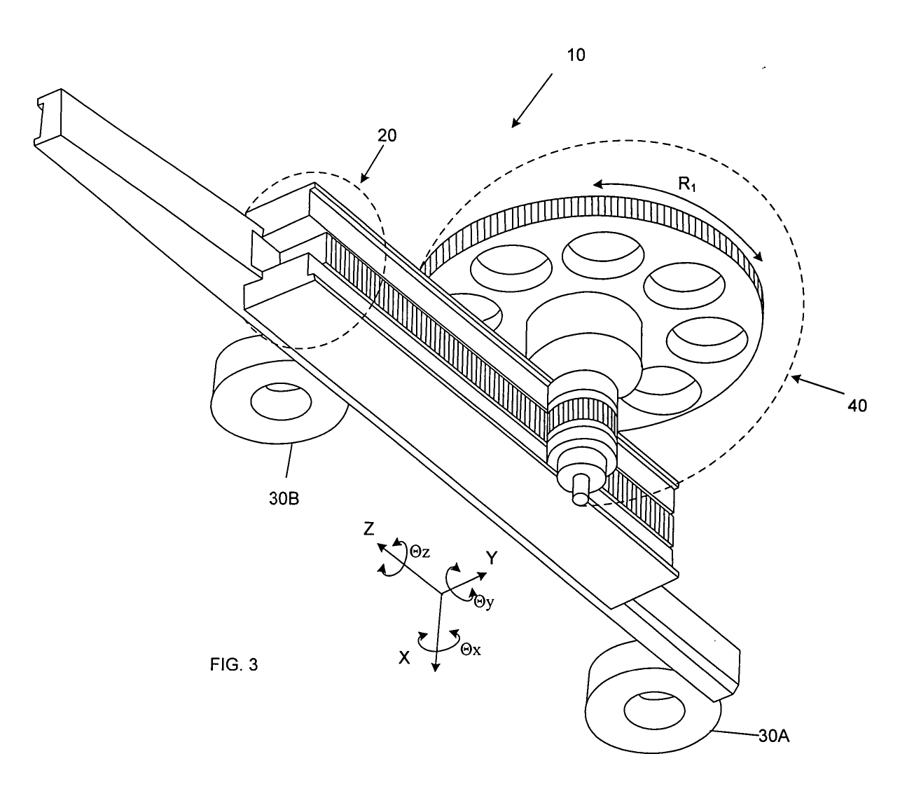

Depicted in FIG. 3, for reference purposes are the three primary axis, X, Y, and Z; and, rotational direction, Θx, Θy, and Θz, denoting rotation around any of the aforementioned X, Y, and Z-axis. A feature of the present invention is that the rack and pinion drive system 10, utilizing a minimal number of parts, may be able to offer a drive system that provides motion relative to a rack unit 20 in one axis (e.g., Z-axis), while the rack unit 20 is concurrently not able to move in either the X or Y axis, nor is the rack unit 20 able to rotate in any Θ (i.e., around X, Y, or Z axis).

The drive system 10 may comprise a motor 80, a rack unit 20, a drive gear 40, and at least one bearing 30. Together, the parts of the drive system 10 provide for a low friction rack and pinion drive that has unique qualities, amongst them the paucity of working parts and elegance of design so as to carry the motive force generated at, for example, a miniature servo motor 80 (See FIG. 4) through this drive system 10 to the requisite application. In one embodiment, the drive system 10 can be applied within a surface mount component placement machine, as typically used in the printed circuit board industry, to provide the vertical (i.e., up and down) motion to each of the vacuum spindle(s) in the component machine. The low friction and low mass of the drive system 10 enables the use of motor current as a precise and fast measurement for the touchdown force exerted by the tip of vacuum nozzle 60 on components and circuit boards.

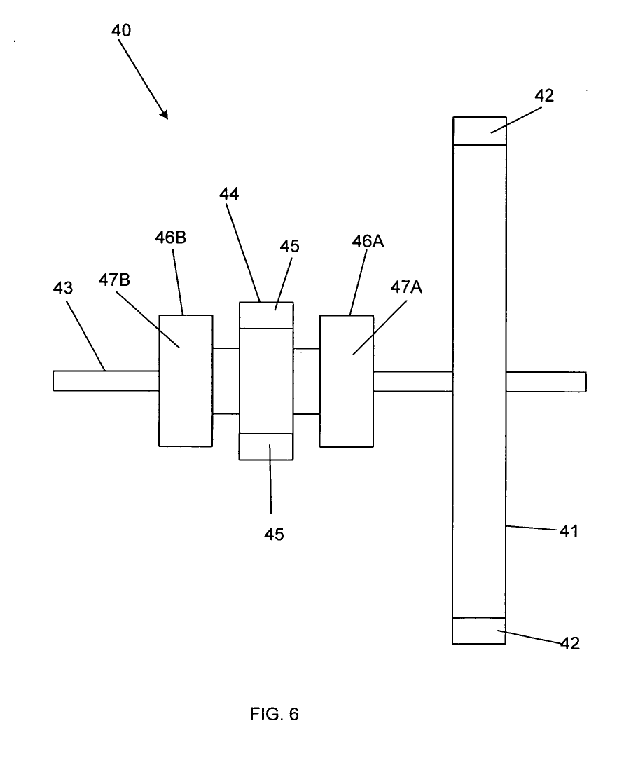

Depicted in FIG. 6 is drive gear 40 which may include a plurality of teeth 42 located on the periphery of a gear wheel 41. Coaxial to the gear wheel 41 and sharing axle 43 may be a pinion gear 44 similarly having a plurality of teeth 45 on its periphery. The axle 43 may include one, or more, rollers 46. In the embodiment shown, there are two rollers 46A, 46B, that are both coaxial with both the pinion gear 44 and gear wheel 41. The rollers 46A, 46B, have a relatively smooth outer wear surface 47A, 47B.

Accordingly, rotation of the drive gear 40 as a unit, as depicted by rotational arrow R₁ (See FIG. 3), entails rotation of the gear wheel 41, the axle 43, the pinion gear 44, and, depending on the embodiment, sometimes the roller(s) 46. For, the rollers 46A, 46B may be fixed to the axle 43, or, alternatively, may freely rotate independently about the axle 43. Similarly, rollers 46A, 46B may be integrated with the pinion gear 44, or made of separate pieces from the pinion gear 44.

FIG. 4 shows a bottom sectional view of the drive system 10. In this embodiment, the axle 43 may freely rotate within trunnions 90A, 90B. Motor 80 may provide rotational force as carried to a motor pinion 81. Gear teeth 82 of motor pinion 81 may engage with teeth 42 of gear wheel 41. Thus, as motor 80 exerts rotational force to motor pinion 81, ultimately, axle 43 may be rotated.

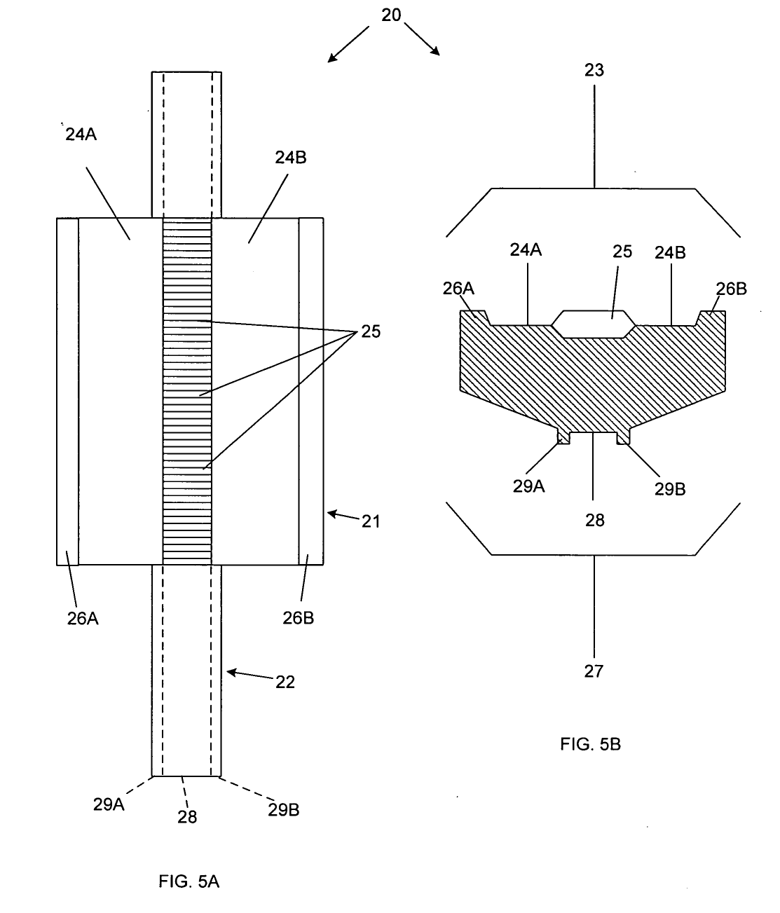

The rack unit 20, depicted in FIGS. 5A and 5B, may have a first face 23 and a second face 27. The first face 23 may be opposed to the second face 27. Along the first face 23 may be a rack, proper, 21 which similarly includes a plurality of teeth 25.

A roller surface extension 22 may include a second surface 28 which is on the second face 27 of the rack unit 20. The second surface 28 may be elongated in shape and may extend, depending on the configuration, in length, further than the length of the rack 21.

In rotatable engagement with the second surface 28 of the rack 21 may be at least one bearing 30 (See e.g., FIG. 4) having a bearing surface 31 that may ride along the second surface 28. In the embodiment shown, the drive system 10 includes only two bearings (i.e., 30A, 30B), each having a bearing surface 31A, 31B, respectively. The bearing surfaces 31A, 31B may ride along the second surface 28. Adjacent to, and extending away from the second surface 28 may be a pair of extensions 29A, 29B on either side of the second surface 28. The extensions 29A, 29B, which, for example, may be configured as lips, may be arranged opposite, and parallel to each other, so as to straddle the width of the bearing surfaces 31A, 31B of the bearings 30A, 30B.

The rack unit 20 may also include a first surface 24 on which the roller surfaces 47 bear. The first surface 24, which is on the first face 23, may be two similarly shaped, and parallel, relatively smooth surfaces (e.g., 24A, 24B, in FIG. 4) located on either side of the rack 21. Functionally, similar to the purpose of the extensions 29 adjacent to the second surface 28, there may be two extensions 26A, 26B adjacent to the first surfaces 24A, 24B. The extensions 26A, 26B, may be spaced apart so as to straddle the width of the roller surfaces 47A, 47B.

In this manner, the entire rack unit 20 may be prevented from falling out of its single axis of movement (e.g., in the Z-axis). For example, rollers 46A, 46B may act in consort with bearings 30A, 30B to prevent the rack unit 20 from moving laterally in the Y-axis. So too extensions 26A, 26B may act in consort with extensions 29A, 29B to prevent the rack unit 20 from lateral movement in the X-axis. Rotation about the Z-axis may be prevented by rollers 46A, 46B, rotation about the X-axis may be prevented by bearings 30A, 30B, and rotation about the Y-axis may be prevented by extensions 26A, 26B acting in consort with extensions 29A, 29B.

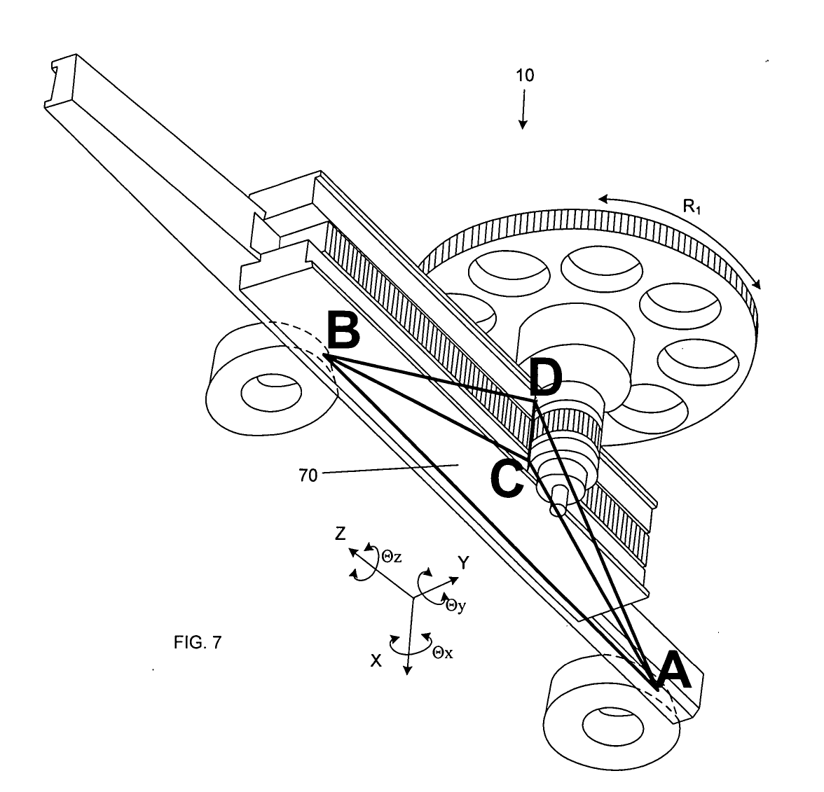

FIG. 7 shows a tetrahedron pyramid 70 superimposed on the low friction rack and pinion drive system 10 depicted in FIG. 3. The pyramid 70 may have four points of intersection: A, B, C, and D. Points A and B may be the contact points of second surface 28 with bearing surfaces 31A and 31B, respectively. Point C may be the contact point of roller surface 47A with first surface 24A. Point D may be the contact point of roller surface 47B with first surface 24B. Connecting lines between points A, B, C & D virtually creates pyramid 70. Line A-B of pyramid 70 may facilitate the prevention of the rotation of drive system 10 about the X-axis axes and lateral support by extensions 29 along line A-B prevent rotation of drive system 10 about the Y-axis. Moreover, line C-D, of pyramid 70, may facilitate the prevention of the rotation of drive system 10 about the Z-axis. Therefore, it is in this manner that, via a tetrahedral configuration having a minimal amount of contact points such as pyramid 70, an improved drive system for pick and place machines may be created.

It should be apparent to one skilled in the art of drive systems that variations of the present invention may include movement in a single axis and may alternatively include either Y-axis or X-axis movement.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

We claim:

1. A spindle assembly drive system comprising:
a rack unit, having a plurality of teeth;
a drive gear, engaged to said rack unit, providing a first contact point and a second contact point to said rack unit;
a motor, engaged to said drive gear, providing rotational force to said drive gear; and
a plurality of bearings, configured to operate having at least a third contact point and a fourth contact point engaged with said rack unit, wherein said rack unit laterally moves in a first axis.

2. The drive system of claim 1 wherein said motor is a servo.

3. The drive system of claim 1 wherein a motor current corresponding to said motor is utilized to facilitate touchdown force measurement.

4. The drive system of claim 1 wherein said drive gear further comprises a plurality of rollers operably placed to facilitate precision positional movement of the drive system.

5. The drive system of claim 1, wherein said rack unit further comprises means to prevent lateral movement of said rack unit along a second axis.

6. The drive system of claim 3, wherein said rollers act in consort with said plurality of bearings to prevent lateral movement of said rack unit along a third axis.

7. The drive system of claim 1 wherein said plurality of bearings is two bearings, and further wherein said two bearings prevent said rack unit from rotating about said second axis.

8. The drive system of claim 4 wherein said means to prevent lateral movement of said rack unit further prevents said rack unit from rotating about said third axis.

9. The drive system of claim 1 wherein the operable placement said rollers prevent said rack unit from rotating about a first axis.

10. A component pick and place machine comprising:
a means for transporting a circuit board through said machine;
a means for selecting from a plurality of components; and
a plurality of vacuum spindles, each of said vacuum spindles having a drive system, said drive system comprising the system of claim 1.

11. A method comprising:
providing a rack unit, having a plurality of teeth;
rotatably engaging a drive gear to said rack unit;
providing a plurality of bearings rotatably engaged with said rack unit; and
moving said rack unit along a first axis by engaging a motor providing rotational force with said drive gear operable with said rack unit;
wherein said plurality of bearings and said drive gear prevent movement of said rack unit along a second axis and a third axis.

12. The method of claim 11, further wherein said plurality of bearings and said drive gear prevent rotation of said rack unit about at least one of said first axis, second axis, and third axis.

13. The method of claim 11 further comprising measuring touchdown force of a vacuum nozzle via a motor current corresponding to said motor.

14. A drive system comprising:
a motor;
a drive gear, operatively attached to said motor;
a rack unit, engaged to said drive gear, said rack unit further comprising a first roller surface; and
two bearings rotatably engaged to said first roller surface;
wherein said drive gear and two bearings provide at least four support points to said rack unit.

15. The drive system of claim 14, wherein said drive gear further comprises at least one roller configured to engage said rack unit.

16. The drive system of claim 15, wherein said rack unit further comprises a second roller surface configured to engage at least one roller.

17. The drive system of claim 16, wherein said first roller surface and said second roller surface are along opposed faces of said rack unit.
